(19) United States
(12) Patent Application Publication
(10) Pub. No.: US 2014/0222622 A1
(43) Pub. Date: Aug. 7, 2014

(54) Method and Apparatus for Collaborative Filtering for Real-Time Recommendation

(71) Applicants: Nan Du, Beijing (CN); Jilei Tian, Beijing (CN)

(72) Inventors: Nan Du, Beijing (CN); Jilei Tian, Beijing (CN)

(73) Assignee: Nokia Corporation, Espoo (FI)

(21) Appl. No.: 14/122,403

(22) PCT Filed: May 27, 2011
(86) PCT No.: PCT/CN2011/074805

§ 371 Date: Mar. 31, 2014

(51) Int. Cl. G06Q 30/06

(52) U.S. Cl. CPC G06Q 30/0627
USPC 705/26.63

(57) ABSTRACT

An approach is provided for generating one or more recommendations to a user based on interactions the user may have with items or topics of interest. The approach involves processing and/or facilitating a processing of one or more interactions of a user with one or more content items. The approach further involves causing, at least in part, an accumulation of the one or more processed interactions of the user. The approach also involves causing, at least in part, a determination of one or more user preferences based, at least in part, on the accumulated one or more processed interactions. The approach additionally involves causing, at least in part, a generation of a rating score of the user for the topic based, at least in part, on the one or more user preferences.

### BACKGROUND

Service providers and device manufacturers (e.g., wireless, cellular, etc.) are continually challenged to deliver value and convenience to consumers by, for example, providing compelling network services. One area of development has been the use of recommendation systems to provide users with suggestions or recommendations for content, items, etc. available within the services and/or related applications (e.g., recommendations regarding people, places, or things of interest such as companions, restaurants, stores, vacations, movies, video on demand, books, songs, software, articles, news, images, etc.). For example, a typical recommendation system may suggest an item to a user based on a prediction that the user would be interested in the item—even if that user has never considered the item before—by comparing the user's preferences to one or more reference characteristics. Such recommendation systems historically have been based on collaborative filters that rely on often large amounts of user data (e.g., historical explicit rating and preference information). However, such user data often is not available or has not been collected with respect to a particular service or application.

### Some Example Embodiments

Therefore, there is a need for an approach for generating one or more recommendations for one or more users based, at least in part, on historical user ratings and/or preferences that are generated by considering historical interactions with one or more content items.

According to one embodiment, a method comprises processing and/or facilitating a processing of one or more interactions of a user with one or more content items. The method also comprises causing, at least in part, an accumulation of the one or more processed interactions of the user. The method further comprises causing, at least in part, a determination of one or more user preferences based, at least in part, on the accumulated one or more processed interactions. The method additionally comprises causing, at least in part, a generation of a rating score of the user for the topic based, at least in part, on the one or more user preferences.

According to another embodiment, an apparatus comprises at least one processor, and at least one memory including computer program code, the at least one memory and the computer program code configured to, with the at least one processor, cause, at least in part, the apparatus to process and/or facilitate a processing of one or more interactions of a user with one or more content items. The apparatus is also caused to cause, at least in part, an accumulation of the one or more processed interactions of the user. The apparatus is further caused to cause, at least in part, a determination of one or more user preferences based, at least in part, on the accumulated one or more processed interactions. The apparatus is additionally caused to cause, at least in part, a generation of a rating score of the user for the topic based, at least in part, on the one or more user preferences.

According to another embodiment, a computer-readable storage medium carries one or more sequences of one or more instructions which, when executed by one or more processors, cause, at least in part, an apparatus to process and/or facilitate a processing of one or more interactions of a user with one or more content items. The apparatus is also caused to cause, at least in part, an accumulation of the one or more processed interactions of the user. The apparatus is further caused to cause, at least in part, a determination of one or more user preferences based, at least in part, on the accumulated one or more processed interactions. The apparatus is additionally caused to cause, at least in part, a generation of a rating score of the user for the topic based, at least in part, on the one or more user preferences.

According to another embodiment, an apparatus comprises means for processing and/or facilitating a processing of one or more interactions of a user with one or more content items. The apparatus also comprises means for causing, at least in part, an accumulation of the one or more processed interactions of the user. The apparatus further comprises means for causing, at least in part, a determination of one or more user preferences based, at least in part, on the accumulated one or more processed interactions. The apparatus additionally comprises means for comprises causing, at least in part, a generation of a rating score of the user for the topic based, at least in part, on the one or more user preferences.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of generating one or more recommendations for one or more users based, at least in part, on historical user ratings and/or preferences that are generated by considering historical interactions with one or more content items, according to one embodiment;

FIG. 2 is a diagram of the components of a recommendation platform that generates one or more recommendations for one or more users based, at least in part, on historical user ratings and/or preferences that are generated by considering historical interactions with one or more content items, according to one embodiment;

FIG. 3A-3D are flowcharts of processes for generating one or more recommendations for one or more users based, at least in part, on historical user ratings and/or preferences that are generated by considering historical interactions with one or more content items, according to one embodiment;

FIG. 4 is a diagram of a user interface for inputting initial preferences and/or ratings for categories or topics, according to one embodiment;

FIG. 5 is a diagram of a user interface for interacting with a content item, according to one embodiment;

FIG. 6 is a diagram of a user interface illustrating a rating for a category or topic, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for generating one or more recommendations for one or more users based, at least in part, on historical user ratings and/or preferences that are generated by considering historical interactions with one or more content items are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term content item refers to any item of interest such as, for example but not limited to, any person, place or thing, a restaurant, a coupon, event, item for sale, store, news article, internet link, movie, television show, travel destination, etc.

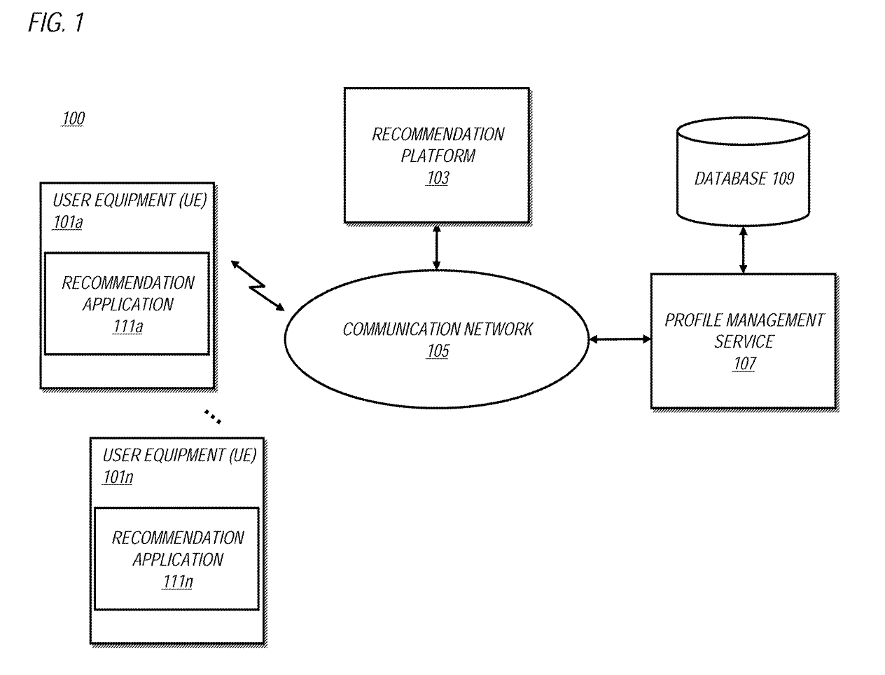

FIG. 1 is a diagram of a system capable of generating one or more recommendations for one or more users based, at least in part, on historical user ratings and/or preferences that are generated by considering historical interactions with one or more content items, according to one embodiment.

Modern consumers are inundated with choices from a huge selection of products, so a recommender system is a salient part of most e-commerce platforms. Collaborative Filtering (CF) is a core technology of most modern recommender systems, which analyzes relationships between users and interdependencies among products to identify new user-item associations. Most CF based recommender systems rely on ratings that reflect a users' specific preferences about items of interest. Most methods require explicit feedback such as a numerical, letter or a star rating-scale that may be received from a user in the form of numbers between 1 and 5 from strongly reject to strongly accept, or letter ratings as “A+,” “A,” “A−,” “B+,” “B,” . . . “F,” for example. While explicit feedback is a direct way to understand user preference, most users do not go through the process of indicating their explicit preferences and/or ratings.

Other CF platforms utilize implicit feedback that is usually received as binary values (0 or 1), e.g., “bought”-vs-“didn't buy”, “viewed”-vs-“didn't view.” For example, if a user is viewing a website, he may or may not buy an item for sale, an implicit feedback would be a simple yes or no indication as to whether the user is interested in the particular item. But, other, more in depth, feedback may be available to more finely tune a user's interest in a content item based on the user's interaction with the content item beyond that which is available by a simple binary collection of data. Some user interactions may be, for example, when surfing the interne, any of the following: “view,” “click,” “add to wish list,” “add to cart,” or “purchase.” A binary implicit feedback model, in this case, would only assign a yes or no value to whether a user performed a particular action.

While some users might have the following actions that correspond to different level of interest, “do not recommend,” “recommended but not view,” “view,” “forward,” “add to favorite list,” “join a group,” or “grab a coupon,” for example, the most common actions in the system might be “recommended but not view” and “view.” However, even if two users have the same “view” action on the same item, there still may be some difference in each user's actual level of interest in the item.

To address these problems, a system 100 of FIG. 1 introduces the capability to generate one or more recommendations for one or more users based, at least in part, on historical user ratings and/or preferences that are generated by considering historical interactions with one or more content items.

In one embodiment, a user may have an opportunity to interact with a content item and rate that item on a scale of 1-5 in a system 100. An item j, may have a basic rating value of 3 in the scale of 1-5 assigned to it because a user viewed item j on a website. In this example, assume that User A is very interested in item j, and User B is not. But, because each of User A and User B have viewed the item j, they have, therefore, implicitly rated item j a “3.” Yet, we know that if user A is originally interested in item j but User B is not, so the implicit basic rating of “3” does not tell the whole story. In this case, if User A and User B had the opportunity to rate his interest in item j, User A may give item j a rating of 3.8 while user B may give item j a rating of 3.1. But the basic mechanism that merely assigns a rating value to an action may not represent such a nuance.

A recommendation to a user about an item of interest or a content item may be based on the user's own or a trusted user's interest level and familiarity with the item. A more accurate estimation and assignment of a user's actual interest level may be helpful in making a more relevant recommendation to the user or any other user of the system 100 that is in line with their interests. Once the user's interest level is assessed, a rating may be assigned, and the estimated rating may be used in a CF-model. The estimated rating may also be combined with any explicit ratings made by the user to further enhance the relevancy of any recommendation.

A user's preference may be constantly updated while the user interacts with any content items. For example, the user may have many positive interactions with any content items such as offers for sale, coupons, places of interest, etc. that the user likes, such as “save to folder,” “recommend to friends,” “put comments,” etc. All of the user's interactions may be saved and processed. Through accumulating such interaction information, the user's preference with regard to a content item, or topic of interest, is incrementally formed.

The system 100 differentiates the level of interest of User A from User B, despite having the same interaction with an item of interest. For example, if User A has historically shown a strong interest in Chinese cuisine, then User A's interaction with an advertisement about a Chinese restaurant, for example, may be more highly ranked or heavily weighted when formulating User A's rating of the Chinese restaurant than an interaction by User B, who historically has not been interested in Chinese cuisine, but still clicks on the deal for the Chinese restaurant.

On the other hand, if a user preference shows little interest in Chinese cuisine, but occasionally she views or even adds an advertisement about Chinese food to his list of favorites, or bookmarks, for example, then it might also indicate some interest of the given user in this particular item, although generally she has low preference to Chinese food. For example, suppose that User A has generally a strong preference to electronic devices based on his browsing history, while User B prefers Chinese cuisine. Occasionally, User A clicks a deal about Chinese food. Although User A prefers electronic devices, this occasional “view” action on such deal may imply that this particular deal does attract his attention. As a result, if both User A and User B view the same Chinese food, User A's action in fact provides more information regarding User A's interest in that topic, which may be surprising.

The system 100 may take both of the two aforementioned situations into consideration by projecting user preference to implicit rating space of different user actions. For example, a basic rating definition may be given to each possible user action as follows:

do not recommend (1)
recommended but not view (2)
view (3)
forward (3)
add to favorite list (4)
join a group (4)
grab a coupon (5)

Each item belongs to a specific category defined from C1 to Cn. In this example, whenever a user newly registers into the system such as a social network, a shopping or travel website, etc., the user may be asked to choose some categories in which the user is interested. Alternatively, or in addition to the explicit basic interest ratings, the user's preferences may be updated based on the frequency of interaction the user may have with categories of items during a given time period. In this example, the user's preferences may be modeled as a vector.

For example, User A's initial preference vector is (1,0,1) corresponding to 3 different categories (C1, C2, C3). Also assume, in this example, that User A has interacted (such as “view”, “forward”, “add to favorite list” etc.) with the following items, I1 (1, 0, 0), I2 (1, 0, 0), I3 (1, 0, 0), I4 (0, 0, 1). Three items belong to category C1 and one belongs to category C3, so User A's preference vector is updated by (1+1+1+1, 0, 1+1) and then normalized to (2/3, 0, 1/3).

Next, User B takes action j on item i. User B's normalized user preference vector is defined as (P0, . . . Pk, . . . , Pn−1). If item i's category is Ck, then the implicit rating that User B gives item i based on action j is defined as:

R(B,i,j)=Base(j)+step*(alpha*Pk+(1−alpha)*(1−Pk)),

where Base(j) is the basic rating of action j, step controls the number of units to increase, and alpha controls the extent to which each of the aforementioned situations might contribute. Alpha, for example, may be selectable or automatically updated to reflect a user's estimated preference or familiarity with the item or topic of interest.

For example, given User A's preference vector (0.9, 0, 0.1), and User B's preference vector (0.1, 0, 0.9), for the same type of action on the same item, say, “view” on item I1 (1, 0, 0). If step is set to 1 and alpha is 0.9, then for the view action,

User A will rate I1 as being R=3.0+1*(0.9*0.9+(1−0.9)*(1−0.9))=3.82

User B will give R=3.0+1*(0.9*0.1+(1−0.9)*(1−0.1))=3.18

On the other hand, if alpha is set to 0.1,

User A will rate I1 as being R=3.0+1*(0.1*0.9+(1−0.1)*(1−0.9))=3.18

User B will give R=3.0+1*(0.1*0.1+(1−0.1)*(1−0.1))=3.82

Therefore, when alpha is close to 0, users tend to be recommended to items they are more familiar with, yet when alpha approaches to 1, they could be recommended to items that they are not as familiar with. In the end, the preference difference is transferred to the user actions and the rating data is further diversified.

As shown in FIG. 1, the system 100 comprises a user equipment (UE) 101a-101n, referred to collectively as UE 101, having connectivity to a recommendation platform 103 via a communication network 105. The UEs 101a-101n may have connectivity to one another via a communication network 105. The recommendation platform 103 may be used to process a user rating and/or an item rating to generate recommendations for a device (e.g. UE 101) and/or a user of the device. The recommendation platform 103 may exist in the UE 101 or in the service or independently. The UE 101 may include recommendation applications 111a-111n (collectively referred to as recommendation application 111) that generates recommendations for the UE 101 based on recommendation from the recommendation platform 103. The UE 101 and recommendation platform 103 may be connected to a profile management service 107 and a database 109 by way of the communication network 105.

According one embodiment, a user A may interact with a content item such as an item for sale on a website by way of UE 101. User A's interaction with the content item may be any of viewing, buying, forwarding, recommending, rating, etc. User A's interaction with the content item may be accumulated and stored in database 109. The profile management service 107 analyzes the accumulated interactions and formulates an estimated user preference for User A for the content item and/or any related content items that may be of the same genre for example. Based on the user preference that is determined, a rating score may be generated for the content item or topic by the profile management service 107. This estimated rating may be used either alone, or in combination with any explicit ratings input by user A regarding a content item or topic to generate one or more recommendations for user A that are related to topics of interest by way of the recommendation platform 103.

According to another embodiment, a user A may interact with a content item such as an item for sale on a website by way of UE 101. Similarly, a user B may also interact with a content item. Both user A's and user B's interactions with the content item may be any of viewing, buying, forwarding, recommending, rating, etc. Both user A's and user B's interactions with the content item may be accumulated and stored in database 109. The profile management service 107 analyzes the accumulated interactions and formulates estimated user preferences for both user A and user B for the content item and/or any related content items that may be of the same genre for example. Based on the user preferences that is determined, rating scores may be generated for the content item or topic by the profile management service 107 and ranked. This estimated rating may be used either alone, or in combination with any explicit ratings input by user A and user B regarding a content item or topic to generate one or more recommendations for user B that are related to topics of interest by way of the recommendation platform 103.

According to another embodiment, a user A may interact with a content item such as an item for sale on a website by way of UE 101. Similarly, a users B and C may also interact with a content item. Both user A's and user B's interactions with the content item may be any of viewing, buying, forwarding, recommending, rating, etc. Both user A's and user B's interactions with the content item may be accumulated and stored in database 109. The profile management service 107 analyzes the accumulated interactions and formulates estimated user preferences for both user A and user B for the content item and/or any related content items that may be of the same genre for example. Based on the user preferences that is determined, rating scores may be generated for the content item or topic by the profile management service 107 and ranked. The ranked ratings may be used to generate a trust score between users A and B with user C. The trust score may weight a rating score of A or B that ranks above or below the rating of the other of A or B. The weighted estimated rating may be used either alone, or in combination with any explicit ratings input by user A and user B regarding a content item or topic to generate one or more recommendations for user C that are related to topics of interest by way of the recommendation platform 103.

By way of example, the UE 101, recommendation platform 103, and profile management service 107 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

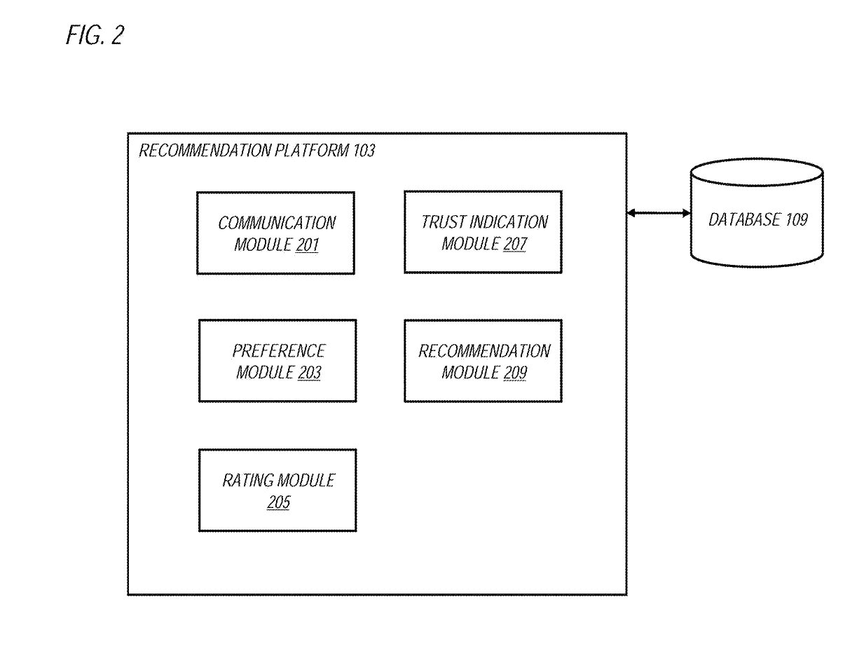

FIG. 2 is a diagram of the components of recommendation platform 103, according to one embodiment. By way of example, the recommendation platform 103 includes one or more components for generating one or more recommendations for one or more users based, at least in part, on historical user ratings and/or preferences that are generated by considering historical interactions with one or more content items. It is contemplated that the functions of these components may be combined in one or more components or performed by other components of equivalent functionality. In this embodiment, the recommendation platform includes a communication module 201, a preference module 203, a rating module 205, a trust indication module 207 and a recommendation module 209.

In one embodiment, the communication module 201 has connectivity with the profile management service 107 and/or the database 109 to receive preference and/or rating information regarding how a user has explicitly or implicitly indicated his ratings and/or preferences about a content item. The preference module 203 processes the preference information to generate a rating and the rating module processes the rating information for generating a recommendation. The trust indication module may rank the processed ratings to determine a trust factor between a user and any other user, and may also consider a familiarity value that a particular user may have with the content item or topic of interest. The familiarity value may be independently selected to be part of the recommendation/rating generating and ranking, and may be exemplified by alpha discussed above. The recommendation module 209 may then make a recommendation to any users of the system 100 based on the user's own indicated ratings and/or preferences and/or any other composite analysis of other users of the system 100. The communication module 201 may then send the recommendation to the UE 101 for presentation to a user of UE 101.

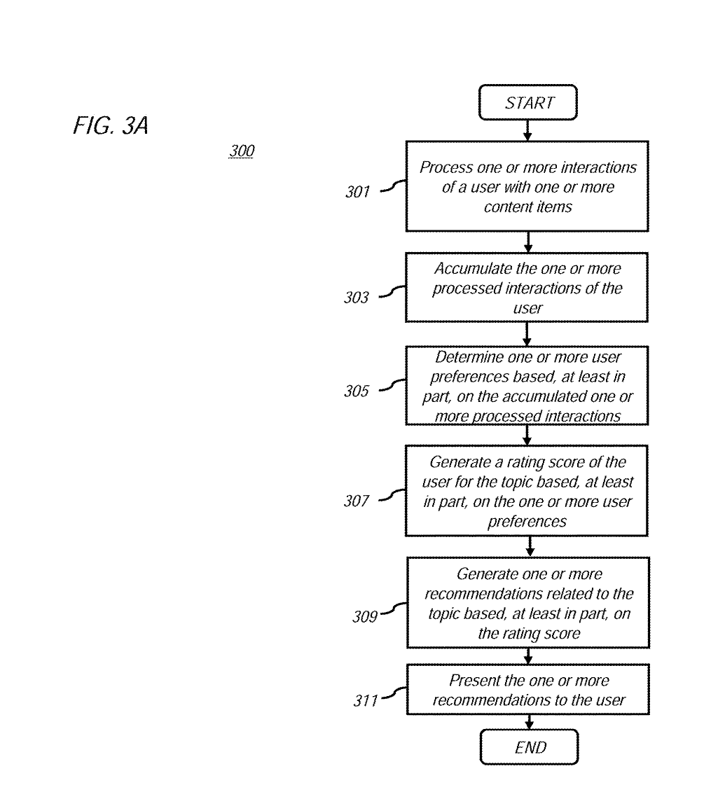

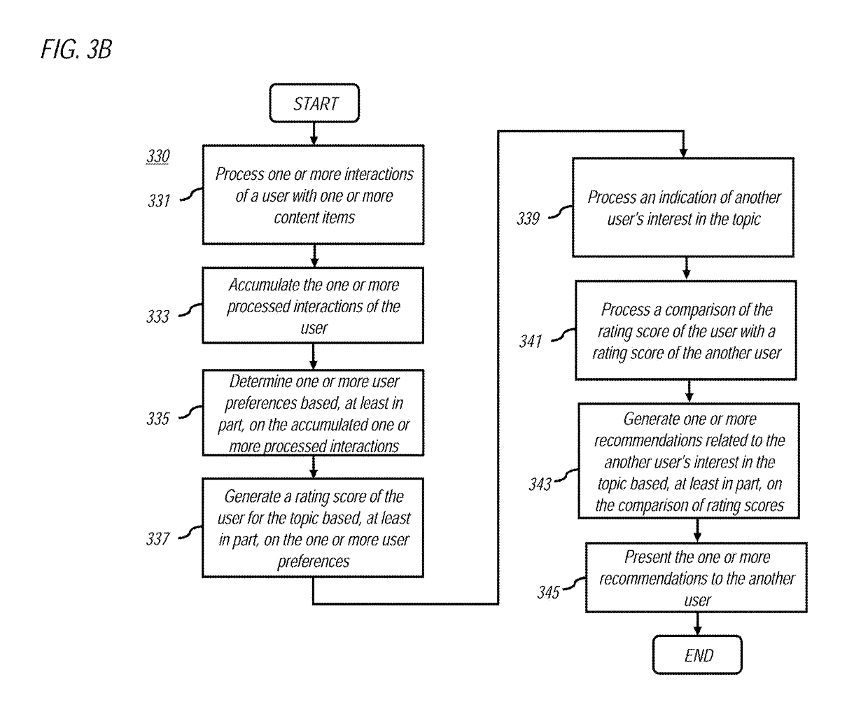

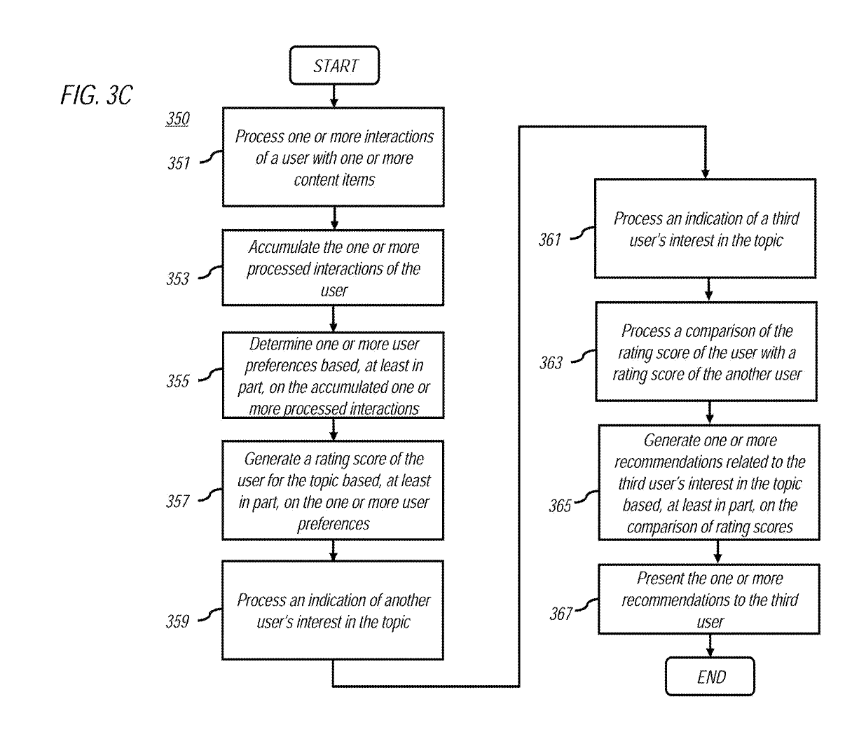

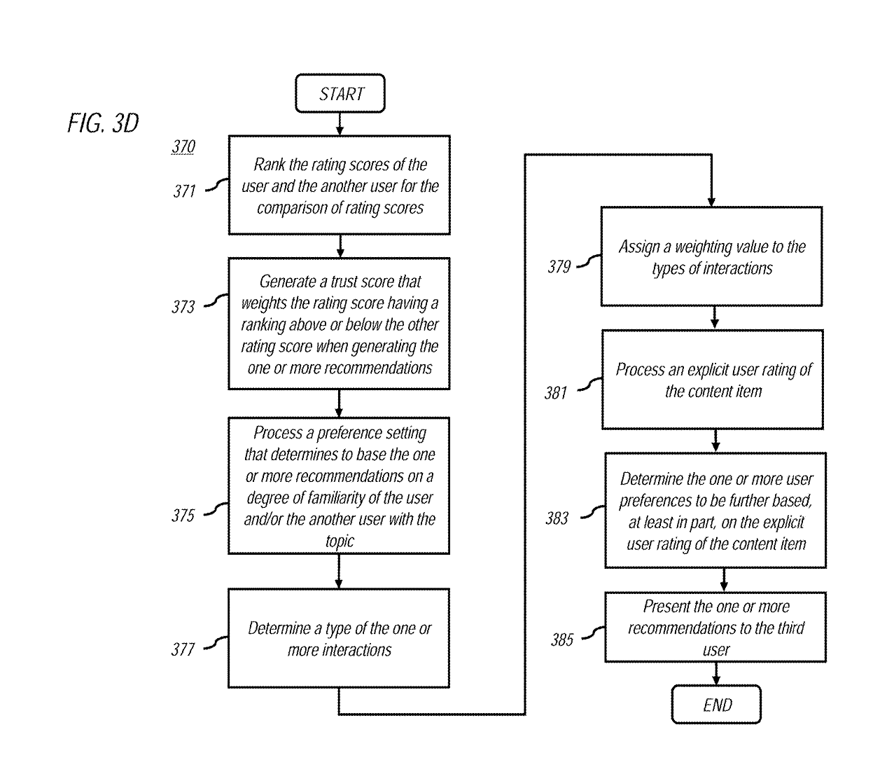

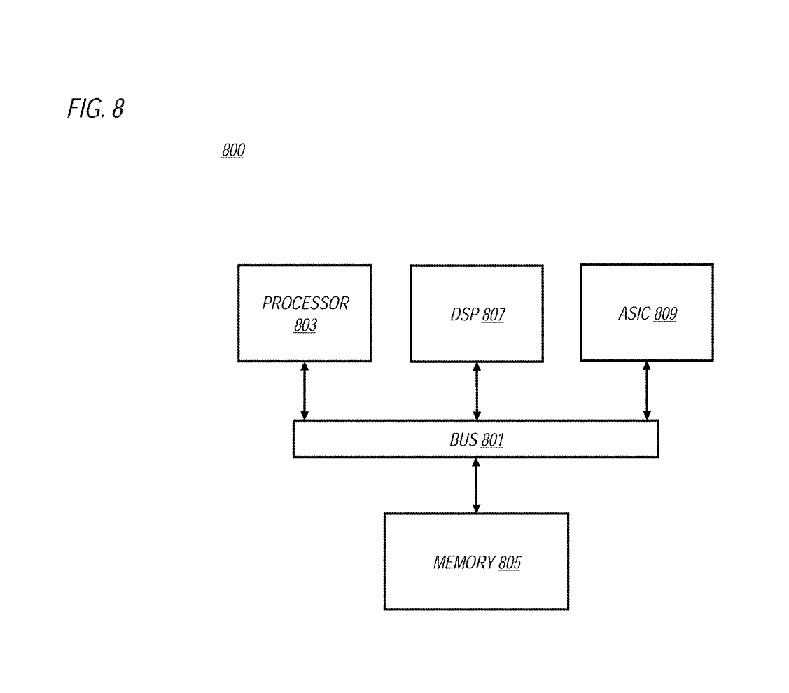

FIGS. 3A-3D are flowcharts for generating one or more recommendations for one or more users based, at least in part, on historical user ratings and/or preferences that are generated by considering historical interactions with one or more content items. FIG. 3A is a flow chart of one embodiment in which the recommendation platform 103 performs the process 300 and is implemented in, for instance, a chip set including a processor and a memory as shown in FIG. 8. In step 301, the recommendation platform processes one or more interaction of a user with one or more content items. The process continues to step 303 in which the one or more interactions are accumulated. Next, in step 305, the recommendation platform determines one or more user preferences based, at least in part, on the accumulated one or more processed interactions. The process continues to step 307 in which the recommendation platform 103 generates a rating score of the user for the topic based, at least in part, on the one or more user preferences. Then, in step 309, the recommendation platform 103 generates one or more recommendation related to the topic based, at least in part, on the rating score. The process continues to step 311 in which the one or more recommendations are presented to the user.

FIG. 3B is a flow chart of one embodiment in which the recommendation platform 103 performs the process 330 and is implemented in, for instance, a chip set including a processor and a memory as shown in FIG. 8. In step 331, the recommendation platform processes one or more interaction of a user with one or more content items. The process continues to step 333 in which the one or more interactions are accumulated. Next, in step 335, the recommendation platform determines one or more user preferences based, at least in part, on the accumulated one or more processed interactions. The process continues to step 337 in which the recommendation platform 103 generates a rating score of the user for the topic based, at least in part, on the one or more user preferences. Then, in step 339, the recommendation platform 103 processes an indication of another user's interest in the topic. Next, in step 341, the recommendation platform 103 processes a comparison of the rating score of the user with a rating score of the another user. Then, in step 343, the recommendation platform 103 generates one or more recommendation related to the another user's interest in the topic based, at least in part, on the comparison of rating scores. The process continues to step 345 in which the one or more recommendations are presented to the another user.

FIG. 3C is a flow chart of one embodiment in which the recommendation platform 103 performs the process 350 and is implemented in, for instance, a chip set including a processor and a memory as shown in FIG. 8. In step 351, the recommendation platform processes one or more interaction of a user with one or more content items. The process continues to step 353 in which the one or more interactions are accumulated. Next, in step 355, the recommendation platform determines one or more user preferences based, at least in part, on the accumulated one or more processed interactions. The process continues to step 357 in which the recommendation platform 103 generates a rating score of the user for the topic based, at least in part, on the one or more user preferences. Then, in step 359, the recommendation platform 103 processes an indication of another user's interest in the topic. Next, in step 361, the recommendation processes an indication of a third user's interest in the topic. The process continues to step 363 in which the recommendation platform 103 processes a comparison of the rating score of the user with a rating score of the another user. Then, in step 365, the recommendation platform 103 generates one or more recommendation related to the third user's interest in the topic based, at least in part, on the comparison of rating scores. The process continues to step 367 in which the one or more recommendations are presented to the third user.

FIG. 3D is a flow chart of one embodiment in which the recommendation platform 103 performs the process 370 and is implemented in, for instance, a chip set including a processor and a memory as shown in FIG. 8. The process starts at step 371 in which the recommendation platform 103 ranks the rating scores of the user and the another user for the comparison of rating scores. The process continues to step 373 in which the recommendation platform 103 generates a trust score that weights the rating score having a ranking above or below the other rating score depending on the order and/or predefined benchmark for ranking order when generating the one or more recommendations. Next, in step 375, the recommendation platform 103 processes a preference setting that determines to based the one or more recommendations on a degree of familiarity of the user and/or the another user with the topic. Then, in step 377, the recommendation platform 103 determines a type of the one or more interactions. The type of the one or more interactions may be any of, for example, an explicit direction to not recommend the one or more content items, an explicit direction to recommend but not view the one or more content items, an action to view the one or more content items, an action to forward the one or more content items, an action forward the one or more content items, an action to favorite the one or more content items, an action to join a group related to the one or more content items, an action to select a coupon related to the one or more content items, or any combination thereof. The recommendation platform 103 may generate one or more basic ratings based, at least in part, on the type of interaction; and then cause the one or more user preferences to be generated based, at least in part, on the type of interaction. The process continues to step 379 in which the recommendation platform 103 assigns a weighting value for the various types of interactions for determining a user's rating for a topic or item based on the user's interactions. Then, in step 381, the recommendation platform 103 processes any explicit rating information that is input by the user. Next, in step 383, the recommendation platform considers the explicit user rating alone, or in combination with, any estimated user rating or preferences based on the user's interaction with the content item to determine one or more user preferences. Then, in step 385, the recommendation platform 103 presents the one or more generated recommendations that are based on the user's interactions, as well as any explicit ratings if available, to the user.

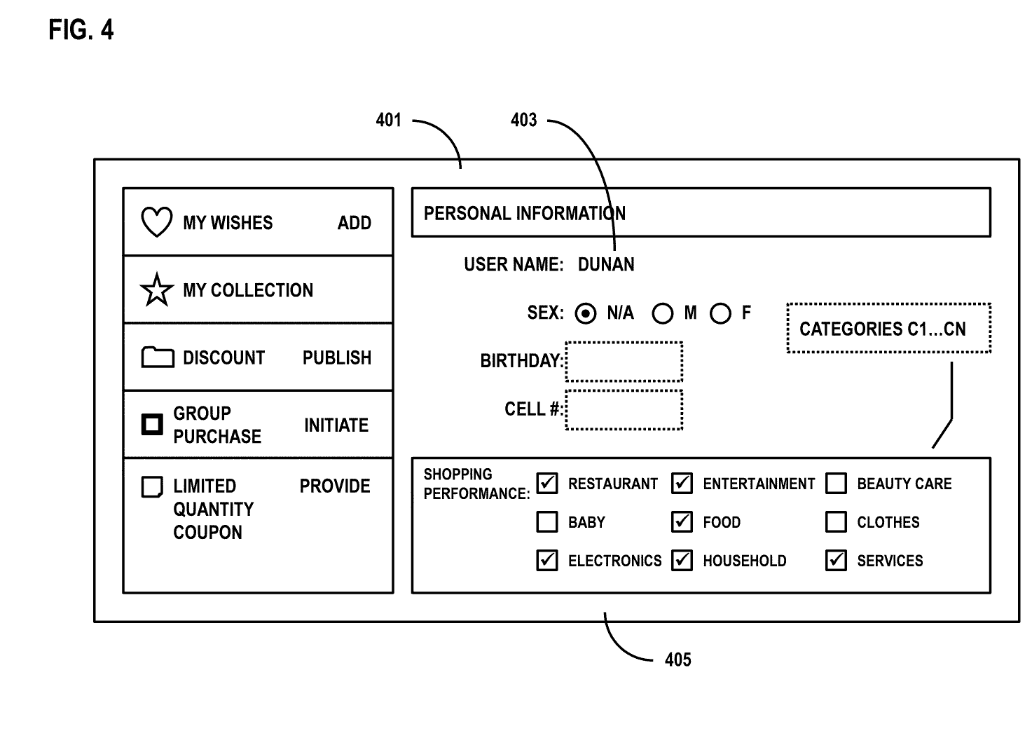

FIG. 4 is a diagram of a user interface utilized in the process of FIG. 3, according to various embodiments. FIG. 4 illustrates a user interface 401 in which a user profile 403 is shown that enable a user to select topics, or categories of interest, 405. The selected categories 405 may serve as an initial indication of interest, or be considered toward determining an implicit rating based on the user's interaction with the category.

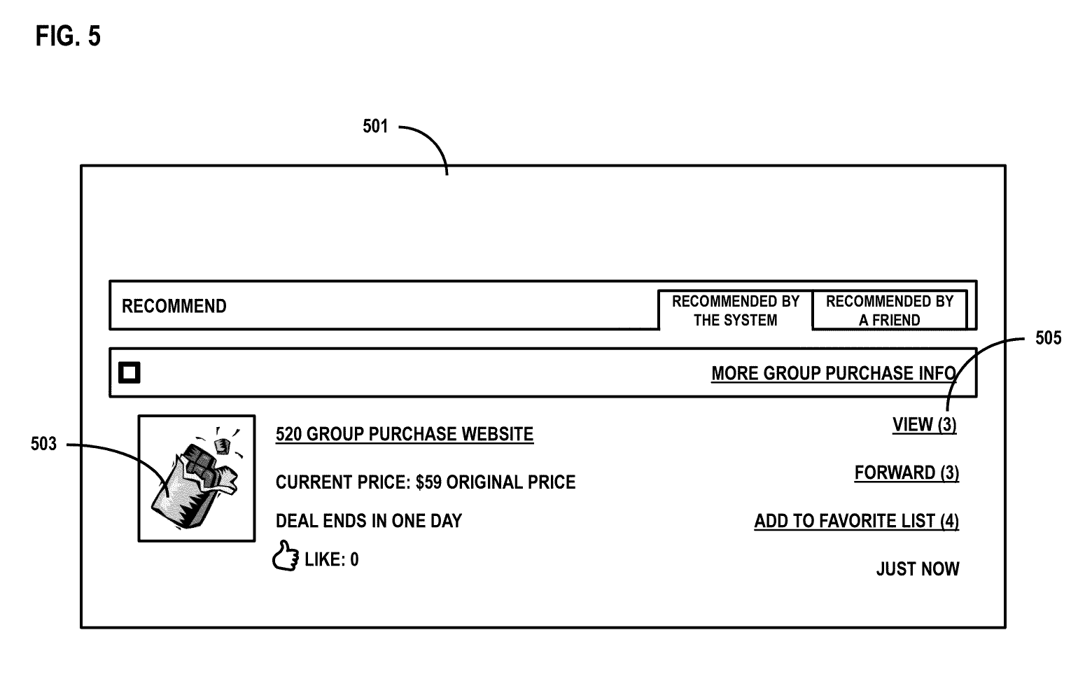

FIG. 5 is a diagram of a user interface 501 that illustrates a website having an item for sale 503. The user has the option to interact with item for sale 503 by selecting any of the interaction options 505. For example, the use may view, forward, or add the item to a favorites list. Each of the interactions 505 may have a particular weighting that may be accumulated and processed to develop an estimated rating of the user based on the user's interaction with the item for sale 501.

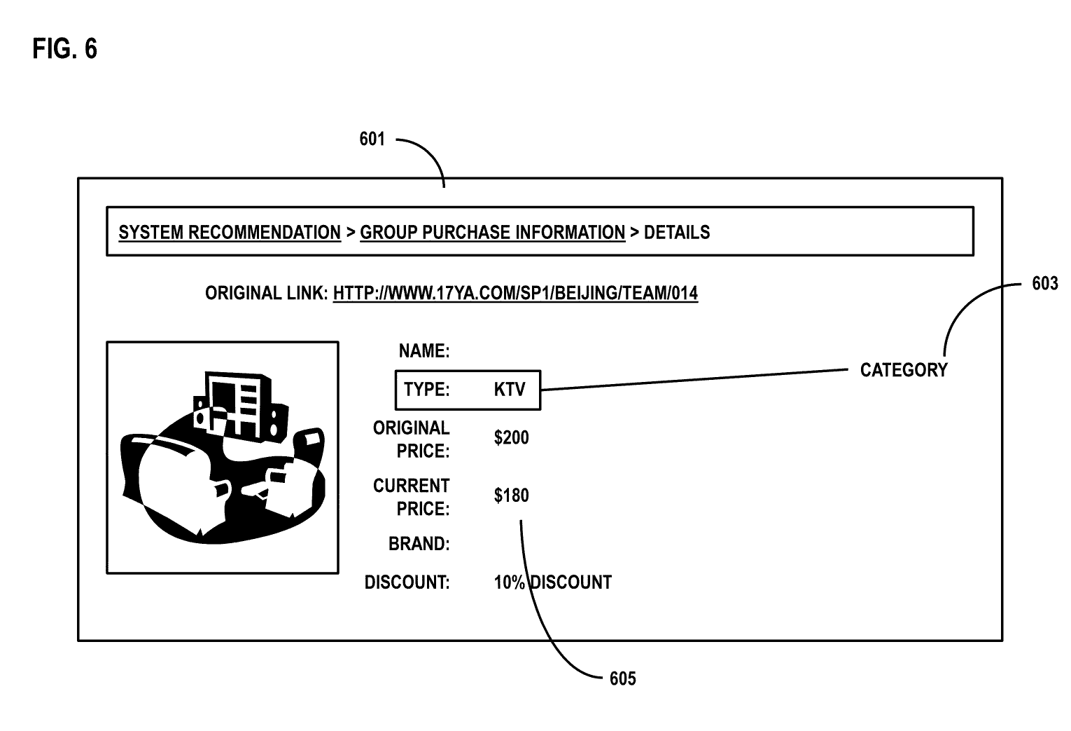

FIG. 6 is a diagram of a user interface 601 that illustrates a particular category or topic of interest 603 and a user rating 605 for the category. The user rating 605, in this example, is 2.9 and may be compiled from the user and/or other users by way of explicit or implicit rating systems.

The processes described herein for generating one or more recommendations for one or more users based, at least in part, on historical user ratings and/or preferences that are generated by considering historical interactions with one or more content items may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

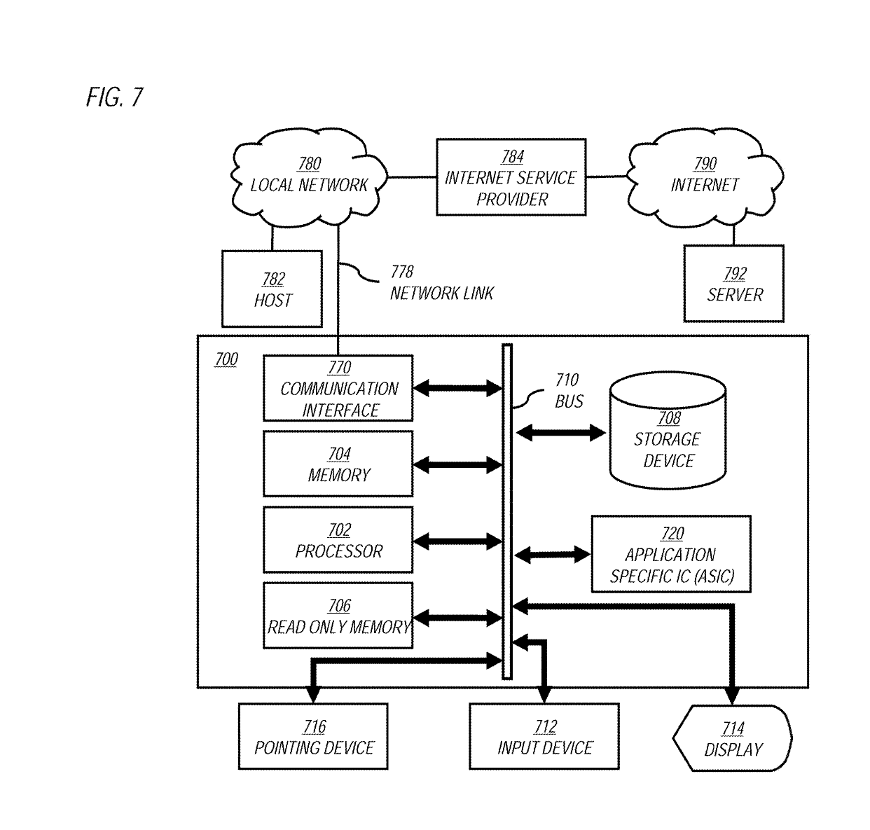

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to generate one or more recommendations for one or more users based, at least in part, on historical user ratings and/or preferences that are generated by considering historical interactions with one or more content items as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of generating one or more recommendations for one or more users based, at least in part, on historical user ratings and/or preferences that are generated by considering historical interactions with one or more content items.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to generate one or more recommendations for one or more users based, at least in part, on historical user ratings and/or preferences that are generated by considering historical interactions with one or more content items. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for generating one or more recommendations for one or more users based, at least in part, on historical user ratings and/or preferences that are generated by considering historical interactions with one or more content items. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for generating one or more recommendations for one or more users based, at least in part, on historical user ratings and/or preferences that are generated by considering historical interactions with one or more content items, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for generating one or more recommendations for one or more users based, at least in part, on historical user ratings and/or preferences that are generated by considering historical interactions with one or more content items to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to generate one or more recommendations for one or more users based, at least in part, on historical user ratings and/or preferences that are generated by considering historical interactions with one or more content items as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of generating one or more recommendations for one or more users based, at least in part, on historical user ratings and/or preferences that are generated by considering historical interactions with one or more content items.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to generate one or more recommendations for one or more users based, at least in part, on historical user ratings and/or preferences that are generated by considering historical interactions with one or more content items. The memory 805 also stores the data associated with or generated by the execution of the inventive steps.

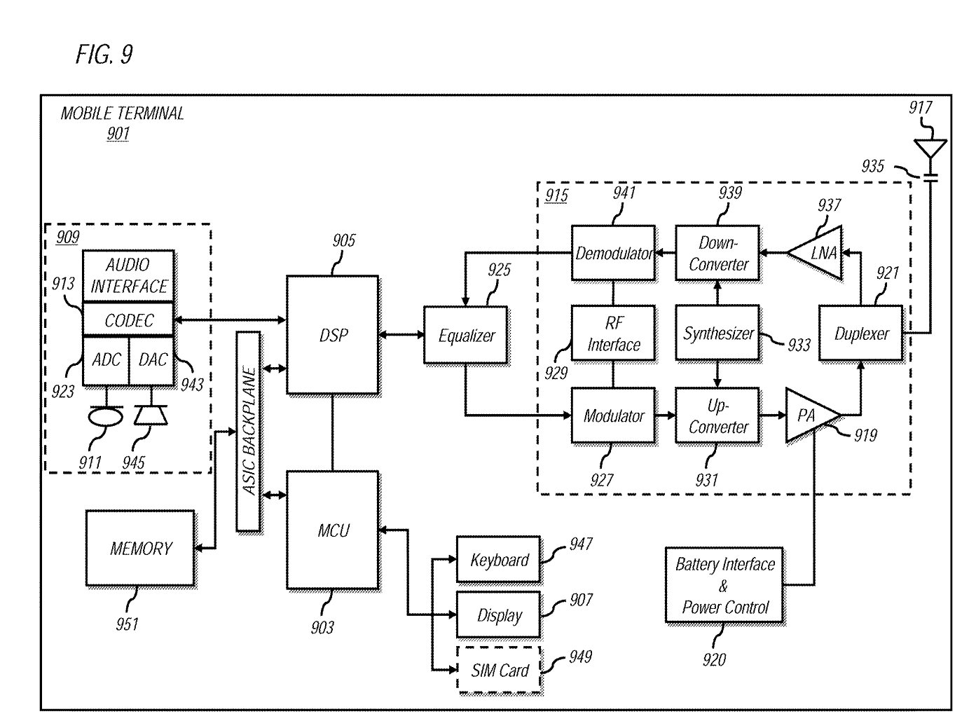

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of generating one or more recommendations for one or more users based, at least in part, on historical user ratings and/or preferences that are generated by considering historical interactions with one or more content items. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of generating one or more recommendations for one or more users based, at least in part, on historical user ratings and/or preferences that are generated by considering historical interactions with one or more content items. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to generate one or more recommendations for one or more users based, at least in part, on historical user ratings and/or preferences that are generated by considering historical interactions with one or more content items. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-38. (canceled)

39. A method comprising facilitating a processing of and/or processing (1) data and/or (2) information and/or (3) at least one signal, the (1) data and/or (2) information and/or (3) at least one signal based, at least in part, on the following:
a processing of one or more interactions of a user with one or more content items;
an accumulation of the one or more processed interactions of the user;
a determination of one or more user preferences based, at least in part, on the accumulated one or more processed interactions; and
a generation of a rating score of the user for the topic based, at least in part, on the one or more user preferences.

40. A method of claim 39, wherein the (1) data and/or (2) information and/or (3) at least one signal are further based, at least in part, on the following:
a generation of one or more recommendations related to the topic based, at least in part, on the rating score; and
a presentation of the one or more recommendations to the user.

41. A method of claim 39, wherein the (1) data and/or (2) information and/or (3) at least one signal are further based, at least in part, on the following:
a processing of an indication of another user's interest in the topic;
a processing of a comparison of the rating score of the user with a rating score of the another user;
a generation of one or more recommendations related to the another user's interest in the topic based, at least in part, on the comparison of rating scores; and
a presentation of the one or more recommendations to the another user.

42. A method of claim 39, wherein the (1) data and/or (2) information and/or (3) at least one signal are further based, at least in part, on the following:
a processing of an indication of another user's interest in the topic;
a processing of an indication of a third user's interest in the topic;
a processing of a comparison of the rating score of the user with a rating score of the another user;
a generation of one or more recommendations related to the third user's interest in the topic based, at least in part, on the comparison of rating scores; and
a presentation of the one or more recommendations to the third user.

43. A method of claim 42, wherein the (1) data and/or (2) information and/or (3) at least one signal are further based, at least in part, on the following:
a ranking of the rating scores of the user and the another user for the comparison of rating scores; and
a generation of a trust score that weights the rating score having a ranking above the other rating score when generating the one or more recommendations.

44. A method of claim 42, wherein the (1) data and/or (2) information and/or (3) at least one signal are further based, at least in part, on the following:
a ranking of the rating scores of the user and the another user for the comparison of rating scores; and
the generation of the one or more recommendations on the rating score having a ranking below the other rating score.

45. A method of claim 42, wherein the (1) data and/or (2) information and/or (3) at least one signal are further based, at least in part, on the following:
a processing of a preference setting that determines to base the one or more recommendations on a degree of familiarity of the user and/or the another user with the topic.

46. A method of claim 39, wherein the (1) data and/or (2) information and/or (3) at least one signal are further based, at least in part, on the following:
a determination of a type of the one or more interactions to be any of an explicit direction to not recommend the one or more content items, an explicit direction to recommend but not view the one or more content items, an action to view the one or more content items, an action to forward the one or more content items, an action forward the one or more content items, an action to favorite the one or more content items, an action to join a group related to the one or more content items, an action to select a coupon related to the one or more content items, or any combination thereof;
a generation of one or more basic ratings based, at least in part, on the type of interaction; and
the one or more user preferences being generated based, at least in part, on the type of interaction.

47. A method of claim 46, wherein the types of interactions are assigned values that weight the types of interactions.

48. A method of claim 39, wherein the (1) data and/or (2) information and/or (3) at least one signal are further based, at least in part, on the following:
a processing of an explicit user rating of the content item; and
the determination of the one or more user preferences being further based, at least in part, on the explicit user rating of the content item.

49. An apparatus comprising:
at least one processor; and
at least one memory including computer program code for one or more programs,
the at least one memory and the computer program code configured to, with the at least one processor, cause the apparatus to perform at least the following,
process and/or facilitate a processing of one or more interactions of a user with one or more content items;
cause, at least in part, an accumulation of the one or more processed interactions of the user;
cause, at least in part, a determination of one or more user preferences based, at least in part, on the accumulated one or more processed interactions; and
cause, at least in part, a generation of a rating score of the user for the topic based, at least in part, on the one or more user preferences.

50. An apparatus of claim 49, wherein the apparatus is further caused to:
cause, at least in part, generation of one or more recommendations related to the topic based, at least in part, on the rating score; and
cause, at least in part, a presentation of the one or more recommendations to the user.

51. An apparatus of claim 49, wherein the apparatus is further caused to:
process and/or facilitate a processing of an indication of another user's interest in the topic;
process and/or facilitate a processing of a comparison of the rating score of the user with a rating score of the another user;
cause, at least in part, generation of one or more recommendations related to the another user's interest in the topic based, at least in part, on the comparison of rating scores; and
cause, at least in part, a presentation of the one or more recommendations to the another user.

52. An apparatus of claim 49, wherein the apparatus is further caused to:
process and/or facilitate a processing of an indication of another user's interest in the topic;
process and/or facilitate a processing of an indication of a third user's interest in the topic;
process and/or facilitate a processing of a comparison of the rating score of the user with a rating score of the another user;
cause, at least in part, generation of one or more recommendations related to the third user's interest in the topic based, at least in part, on the comparison of rating scores; and
cause, at least in part, a presentation of the one or more recommendations to the third user.

53. An apparatus of claim 52, wherein the apparatus is further caused to:
cause, at least in part, ranking the rating scores of the user and the another user for the comparison of rating scores; and
cause, at least in part, a generation of a trust score that weights the rating score having a ranking above the other rating score when generating the one or more recommendations.

54. An apparatus of claim 52, wherein the apparatus is further caused to:
cause, at least in part, ranking the rating scores of the user and the another user for the comparison of rating scores; and
cause, at least in part, basing the generation of the one or more recommendations on the rating score having a ranking below the other rating score.

55. An apparatus of claim 52, wherein the apparatus is further caused to:
process and/or facilitate a processing of a preference setting that determines to base the one or more recommendations on a degree of familiarity of the user and/or the another user with the topic.

56. An apparatus of claim 49, wherein the apparatus is further caused to:
cause, at least in part, a determination of a type of the one or more interactions to be any of an explicit direction to not recommend the one or more content items, an explicit direction to recommend but not view the one or more content items, an action to view the one or more content items, an action to forward the one or more content items, an action forward the one or more content items, an action to favorite the one or more content items, an action to join a group related to the one or more content items, an action to select a coupon related to the one or more content items, or any combination thereof;
cause, at least in part, a generation of one or more basic ratings based, at least in part, on the type of interaction; and
cause, at least in part, the one or more user preferences to be generated based, at least in part, on the type of interaction.

57. An apparatus of claim 56, wherein the types of interactions are assigned values that weight the types of interactions.

58. An apparatus of claim 49, wherein the apparatus is further caused to:
process and/or facilitate a processing of an explicit user rating of the content item; and
cause, at least in part, the determination of the one or more user preferences to be further based, at least in part, on the explicit user rating of the content item.
